(19) United States
(12) Patent Application Publication
(10) Pub. No.: US 2012/0257073 A1
(43) Pub. Date: Oct. 11, 2012

(54) CAPTURING DEVICE

(75) Inventors: BI-QING LUO, Shenzhen City (CN); ZHANG-YONG ZHENG, Shenzhen City (CN); HUI-FENG LIU, Shenzhen City (CN); XUE-SHUN LIU, Shenzhen City (CN); XIN LU, Shenzhen City (CN); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/163,696

(22) Filed: Jun. 19, 2011

(30) Foreign Application Priority Data
Apr. 8, 2011 (CN) 201110087720.2

(51) Int. Cl. H04N 5/228

(52) U.S. Cl. 348/222.1; 348/E05.031

(57) ABSTRACT

A capturing device includes a capturing unit for capturing an image, a compass, a computing unit and a processor. The compass is used for rotating the pointer thereof to a predetermined direction when the capturing device rotates. The computing unit is used for computing an angle and direction rotated by the pointer of the compass in the process of the capturing unit capturing the image. The processor is used for correcting the captured image according to the angle and direction computed by the computing unit.

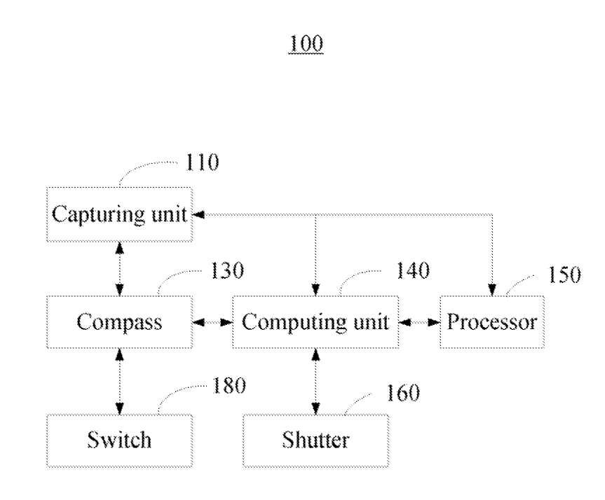

### BACKGROUND

1. Technical Field

The present disclosure relates to electronic devices; and particularly to a capturing device such as a digital camera.

2. Description of Related Art

When using a digital camera to capture an image, a photographer often moves the digital camera to obtain the best capturing angle. However, the digital camera often dithers after the photographer moves the digital camera, thus the quality of the captured image may be degraded.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the view.

The figure is a block diagram of a capturing device in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

Referring to the figure, a capturing device 100 includes a capturing unit 110 for capturing an image, a compass 130, a computing unit 140, a processor 150 and a shutter 160 capable of being in two states: an open state, and a closed state. The capturing device 100 is an electronic device, such as a cell phone, or a digital camera, capable of capturing an image.

The compass 130 is disposed on the housing (not shown) of the capturing device 100, and the pointer of the compass 130 rotates with rotation of the capturing device 100 so that the pointer of the compass 130 points to a predetermined direction when the photographer moves the capturing device 100.

The computing unit 140 is used for computing a first angle and first direction of the pointer of the compass 130 rotating in the process of the capturing unit 110 capturing the image (hereinafter “capturing process”). In the embodiment, the first angle is considered as an angle of the capturing device 100 rotating in the capturing process. A second direction reverse to the first direction is considered as a direction of the capturing device 100 rotating in the capturing process. For example, when the first direction is clockwise, the second direction is counterclockwise. As such, the computing unit 140 can obtain the first angle and second direction of the capturing device 100 rotating in the capturing process by the photographer according to the first angle and first direction of the pointer of the compass 130 rotating in the capturing process. In the embodiment, the capturing process is a period in which the shutter 160 is in the open state.

The processor 150 is used for correcting the captured image according to the first angle and first direction of the capturing device 100 rotating in the capturing process; that is, rotating the captured image through the first angle in the first direction. Therefore, the adverse influence on the captured image caused by dithering is decreased, and the quality of the captured image is improved. The processor 150 also can first determine whether the first angle is at least a predetermined value, and correcting the captured image when the first angle is at least the predetermined value. As such, when the first angle is less than the predetermined value, the processor 150 does not need to correct the captured image. It can reduce time for correcting the captured image.

The capturing device 100 further includes a switch 180 for controlling the compass 130. The compass 130 is enabled when the switch 180 is in a first state, and disabled when the switch 180 is in a second state.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A capturing device, comprising:
a capturing unit for capturing an image;
a compass for rotating with rotation of the capturing device so that the pointer thereof points to a predetermined direction;
a computing unit for computing a angle and direction of the pointer of the compass rotating in the process of the capturing unit capturing the image; and
a processor for correcting the captured image according to the angle and direction computed by the computing unit.

2. The capturing device according to claim 1, wherein the processor corrects the captured image by rotating the captured image through the angle in the direction computed by the computing unit.

3. The capturing device according to claim 1, wherein the processor is used for determining whether the angle is at least a predetermined value, and correcting the captured image when the angle is at least the predetermined value.

4. The capturing device according to claim 1, further comprising a shutter capable of being in two states: an open state, and a closed state; wherein the capturing process is a period in which the shutter is in the open state.

5. The capturing device according to claim 1, further comprising a switch for controlling the compass, the compass being enabled when the switch is in a first state, and being disabled when the switch is in a second state.
